(19) United States
(12) Patent Application Publication
(10) Pub. No.: US 2025/0248557 A1
(43) Pub. Date: Aug. 7, 2025

(54) BEVERAGE POD SYSTEM WITH POD HOLDER

(71) Applicant: SOCIETE DES PRODUITS NESTLE S.A., Vevey (CH)

(72) Inventors: ALEX EISENBART, Andwil (CH); MICHAEL ZULLIG, St. Gallen (CH); SILVIA QUATTRONE, Lausanne (CH); ARAMIA ASMAR, Yverdone-les-bains (CH); FREDERIC FRAGNIERE, Orbe (CH)

(21) Appl. No.: 18/855,031

(22) PCT Filed: Apr. 6, 2023
(86) PCT No.: PCT/EP2023/059105

§ 371 Date: Oct. 8, 2024

(30) Foreign Application Priority Data
Apr. 8, 2022 (EP) 22167449.2

(51) Int. Cl. A47J 31/36; A47J 31/44

(52) U.S. Cl. CPC A47J 31/3628; A47J 31/3633; A47J 31/4492

(57) ABSTRACT

The invention concerns an extraction device for extracting a beverage ingredient by supplying an extraction liquid into a pod, said pod comprising a pod body with a bottom wall and a top lid, said extraction device comprising: —upstream and downstream pod enclosing parts relatively movable, and—a removable pod holder, said holder comprising a pod receiving hole to receive and hold the pod, and—a top insertion section configured for introducing the pod holder in the device and for positioning said holder between the upstream and downstream pod enclosing parts, and wherein the top insertion section is configured to introduce the holder along a vertical direction from the top of the device, and wherein the pod receiving hole and the top insertion section are configured to position the lid of the pod vertically when the removable pod holder is positioned inside the device.

### FIELD OF THE INVENTION

The present invention relates to the field of preparation of beverages with a system including a single-serve container comprising a beverage ingredient and a machine that has an extraction chamber in which the container can be inserted, extracted and from which it can be removed.

### BACKGROUND OF THE INVENTION

Single serve containers for the automatic preparation of beverages encompass various formats of containers that can be extracted according to different types of systems. In these systems, the container introduced by the user inside the system becomes enclosed in a chamber to perform the extraction process and then is removed from the chamber. The chamber comprises two parts configured to be moved apart during the introduction of the container and then moved one to the other to form the extraction chamber around the container for the beverage extraction.

The container can be introduced in these systems according to different manners.

In one first type of system, the user introduces the container inside a receiving area of the system that leads the container directly between the two parts of the machine like in EP 1859714 or EP1646305. In such a type of system, the two parts of the chamber are generally movable one to the other along a horizontal direction and the container can be introduced inside the two parts and then removed from the chamber along the perpendicular vertical direction to take benefit of the gravity fall of the container in these operations.

Accordingly, such a type of system requires the provision of container catchers and container ejectors inside the chamber to control the movement of the container which makes manufacturing more complex.

In addition, this system requires a bin to collect the ejected container below the two parts of the chamber meaning a certain height for the system; this height and this bin increases the cost of production of the system too.

An object of the invention is to address at least the above existing drawbacks.

### SUMMARY OF THE INVENTION

In a first aspect of the invention, there is provided an extraction device for extracting a beverage ingredient by supplying an extraction liquid into a pod, said pod comprising:
a pod body, said pod body comprising a side wall and a bottom wall defining a chamber, and
a top lid closing the top opening of the pod body,
and
said extraction device comprising
upstream and downstream pod enclosing parts relatively movable, preferably translatable, along a horizontal longitudinal axis (XX′) between an open position for inserting and removing the pod and a closed position for forming an extraction chamber enclosing the pod during extraction, and
a removable pod holder, said holder comprising a pod receiving hole to receive and hold the pod, and
a top insertion section configured for introducing the pod holder in the device and for positioning said holder between the upstream and downstream pod enclosing parts,
and
wherein the top insertion section is configured to introduce the holder along a vertical direction from the top of the device, and
wherein the pod receiving hole and the top insertion section are configured to position the lid of the pod vertically when the removable pod holder is positioned inside the device.

The pod holder provides the effect of holding the pod inside the extraction chamber during the extraction operation. Consequently, there is no need to provide the chamber with additional and complex pod catchers and ejectors to receive the pod and eject the pod. The concept of the chamber can remain simple and is less costly.

The pod holder can be introduced inside the extraction device and removed from it manually saving costs of manufacture and of use.

The pod holder, that can be manipulated manually, enables the concept of beverage machine that is deprived of bin and means to move the pod to the bin after preparation. The machine is smaller and less costly.

The pod holder is removable, meaning detachable, from the extraction device.

The pod holder can be fully removed out of the top insertion section. Then, it can be put back in the extraction device. Accordingly, the user can easily introduce the pod inside the holder when the pod holder is outside the extraction device; the user can easily carry the pod holder positioned within the holder to the bin after extraction and then position the pod holder back in the extraction device with or without a new pod.

Preferably, the pod holder comprises orientation means to orientate the pod correctly inside the holder and then inside the extraction device, in particular in view of the downstream or upstream parts depending on the construction of the pod.

In one preferred embodiment, orientation means are configured to orientate the lid of the pod so that it faces either the downstream or upstream part, depending on the construction of the pod.

Such orientation means can be a specific design of the holder and of the insertion path of the extraction device urging the user to position the pod and the pod holder in one manner only.

Preferably, the relative movement of the upstream and downstream enclosing parts is linear.

It is preferably a translation. Preferably, the introduction and removal of the pod holder is linear too and preferably perpendicular to the linear movement of the enclosing parts.

As a result, the dimension of the extraction device can be kept small.

Generally, the upstream part bears an upstream piercing arrangement for opening the bottom wall of the pod and a liquid injector, and the downstream part comprises a downstream piercing arrangement for opening the lid of the pod.

In one particular embodiment, the upstream part defines a cage and the downstream part defines a plate transverse to the longitudinal axis (XX′) and this plate comprises the downstream plane piercing arrangement for opening the lid of the pod.

Generally, the holder and its hole are designed so that once the pod is positioned in the hole, at least a part of the lid and at least a part of the bottom of the pod is not covered or enclosed by the pod holder and remains accessible for being pierced by the downstream and upstream pod enclosing parts during the beverage preparation.

Preferably, the whole surfaces of the lid and the pod body bottom are uncovered by the holder.

Accordingly, these parts remain fully accessible by the piecing elements of the extraction device.

Preferably, each of the downstream and upstream parts are movable between a respective open position for inserting and removing the pod holder and a respective closed position for forming an extraction chamber that encloses the pod holder during extraction.

The movements of each of the upstream and enclosing parts to and away from the pod are preferred because frequently, further to the beverage extraction, a part of the lid or of the bottom of the pod body can remain engaged with the piercing elements rising from said parts.

The movements of these enclosing parts enable the disengagement from the pod and a safe removal of the pod holder.

Preferably, the top insertion section comprises a path for guiding the pod holder to the extraction area between the upstream and downstream pod enclosing parts, and the extraction device comprises a holder stopper to stop the pod holder in an intermediate temporary position inside said path.

This intermediate temporary position can be configured to enable the user to load the device with the pod holder before the holder is further displaced automatically to the brewing chamber formed by the upstream and downstream enclosing parts.

The intermediate position can avoid any manual wrong or incorrect introduction in the core part of the extraction device that is the brewing chamber.

Preferably, the extraction device can comprise a recognition device configured to recognise or identify a pod hold in the pod holder when the pod holder is in the intermediate temporary position. This intermediate position of the holder enables recognition step, for example by an code reader in order to:
provide the process control unit of the extraction device with information related to the beverage preparation (authorised pod, optimal recipe), or
stop the preparation if a defect is identified (already extracted pod that was not removed from the holder) and alert the user through a display. The user can immediately remove the holder and check the pod in the holder.

Preferably, the extraction device can comprise an actuating means to move the pod holder from the intermediate position to the extraction area between the upstream and downstream pod enclosing parts. This actuating means is preferably manually actuated, like a handle. As a result, the pod holder can be manually operated directly, when loading the pod with the pod holder to the intermediate position, and indirectly with the handle moving the pod holder to the extraction area.

Preferably, the actuating means is cinematically linked to the holder stopper so that said stopper is configured to drive the pod holder from the intermediate position to the extraction area when said actuating means is operated.

As a result, even if the actuator is operated manually, the holder is automatically moved to the extraction area which guarantees a correct positioning inside the two enclosing parts. This is preferable when the two enclosing parts are both movable one to the other.

Preferably, the pod holder and the holder stopper are designed so that the holder stopper is able to engage a surface of the pod holder.

Preferably, the actuating means comprises a handle, and this handle closes the path of the top insertion section when the downstream and upstream parts are in the closed position.

Consequently, the movement of the handle can simultaneously drive the holder inside the extraction device and close the path of the insertion section to prevent the user to pull the holder while an extraction operation is happening.

Preferably, the actuating means is configured to move each of the upstream and downstream parts between the open position and the closed position of said parts too.

In particular, the actuating means can be configured to coordinate the movement of the upstream and downstream parts and the movement of the pod holder so that:
the pod holder is positioned in the extraction area between the two enclosing parts before these parts enclose the pod, and
the two enclosing parts are moved away from the pod before the pod holder is removed from the extraction area.

Preferably, when the pod holder is in the extraction area and the upstream and downstream enclosing parts are in the closed position, the surround of the receiving hole of the pod holder is pinched between the upstream and downstream enclosing parts.

Preferably, the pod holder comprises a plate and this plate comprises the hole for receiving the pod, said plate comprising a front face and a back face. In addition, the pod holder comprises a seal, that covers all the front face and back face of the surround of the receiving hole of the pod holder.

Accordingly, the holder participates to the tightness of the extraction chamber during the beverage preparation.

In one embodiment, the part of the seal covering the front face of the plate of the pod holder can comprise a ridge that rises in the downstream direction.

In addition, preferably the downstream enclosing part defines a plate transverse to the longitudinal axis (XX′), and this plate comprises:
a downstream plane piercing arrangement for opening the lid of the pod,
and
a peripheral area,

Preferably, this peripheral area of the downstream enclosing part can comprise a groove that is conformal to the shape of the ridge of the seal, and when the upstream and downstream pod enclosing parts are in the closed position the ridge is positioned inside this groove.

This embodiment is particularly useful to improve the tightness of the extraction chamber when the body of the pod presents wrinkles on its external surface and when the shapes of these wrinkles provide channels for fluid during the beverage preparation. The ridge and the groove close such channels

In a second aspect of the invention, there is provided a beverage preparation machine comprising an extraction device such as described above.

Generally, this beverage machine comprises a liquid supply system connected to the upstream enclosing part. This liquid supply system can comprise:
a liquid supply such as a liquid tank,
pumping means to drive liquid form the liquid supply to the extraction device,
heating and/or cooling means to adapt the temperature of the liquid before it is introduced inside the pod.

The liquid is usually water.

Usually, this beverage machine comprises a control unit configured to control at least the supply of liquid to the extraction device. The control unit can be configured to control the recognition operation of the recognition device if present or to display information to the user.

In a third aspect of the invention, there is provided a system comprising an extraction device such as described above and a pod or comprising a beverage preparation machine such as described above and a pod, wherein this pod comprises:
a pod body, said pod body comprising a side wall and a bottom wall defining a chamber, and
a top lid closing the top opening of the pod body.

In a fourth aspect, there is provided a method to prepare a beverage with a device such as described above, comprising the steps of:
removing the pod holder,
introducing a pod in the pod holder,
introducing the pod holder in the extraction device down to a temporary position,
actuating the actuating means to move the pod holder from the intermediate position to the extraction area.

In a fifth aspect, there is provided a removable pod holder, said holder comprising a pod receiving hole to receive and hold the pod in an extraction device such as described above.

Preferably, the extraction device comprises:
a path for guiding the pod holder to the extraction area between the upstream and downstream pod enclosing parts and
a holder stopper, and
the pod holder is designed to engage this holder stopper.

In the present application:
the term “pod” is used to broadly designate any kind of single-dose container suitable for preparing beverages or other edible products such as capsules, cartridges, portioned or individual packages without limitation to the shape of this container, the material this container is made of or the types of piercing means needed to extract the beverage therefrom.
the term “longitudinally” refers to the orientation of the two enclosing parts one to the other and their movement along the longitudinal axis XX.
the term “vertically”, “upwardly” and “downwardly” refers to the movement of the pod in the extraction device from its introduction between the two enclosing parts and its removal therefrom. The terms “upper” and “lower” refer to this vertical axis too.
the terms “upstream” and “downstream” refer to the path of liquid through the extraction device from the upstream enclosing part to the downstream enclosing part.

Generally, these terms are used to describe the relational positioning of features of the extraction device. These terms should be understood to refer to said device in its normal orientation when positioned in a beverage machine for the production of a beverage as shown in the FIGS. 2A, 2E, and 4A to 4H.

The above aspects of the invention may be combined in any suitable combination. Moreover, various features herein may be combined with one or more of the above aspects to provide combinations other than those specifically illustrated and described. Further objects and advantageous features of the invention will be apparent from the claims, from the detailed description, and annexed drawings.

### BRIEF DESCRIPTION OF THE DRAWINGS

Specific embodiments of the invention are now described further, by way of example, with reference to the following drawings in which:

FIGS. 1A to 1C are different perspective view of pods used in the extraction device of the present invention,

FIGS. 2A and 2D are side and top views respectively of an extraction device according to the invention the pod holder being removed therefrom,

FIGS. 2B and 2C are perspective views of some isolated parts of said extraction device of FIG. 2A,

FIG. 2E is a side view of the extraction device of FIG. 2A with the pod holder enclosed inside and FIG. 2F is side view of some isolated parts of said extraction device of FIG. 2E,

FIGS. 3A and 3B are perspective views of the holder holding a pod,

FIG. 3C is perspective view of the holder without any pod,

FIG. 3D is a bottom view of the holder holding a pod,

FIGS. 4A-4E are cross section views illustrating the steps of introduction of the pod holder inside the extraction device according to the preferred embodiment,

FIGS. 4F-4H are cross section views illustrating the steps of removal of the pod holder from the extraction device according to the preferred embodiment,

FIG. 5 is a magnified view of a part of FIG. 4E,

FIG. 6 illustrates the fluid system of the extraction device.

### DETAILED DESCRIPTION OF EXEMPLARY EMBODIMENTS

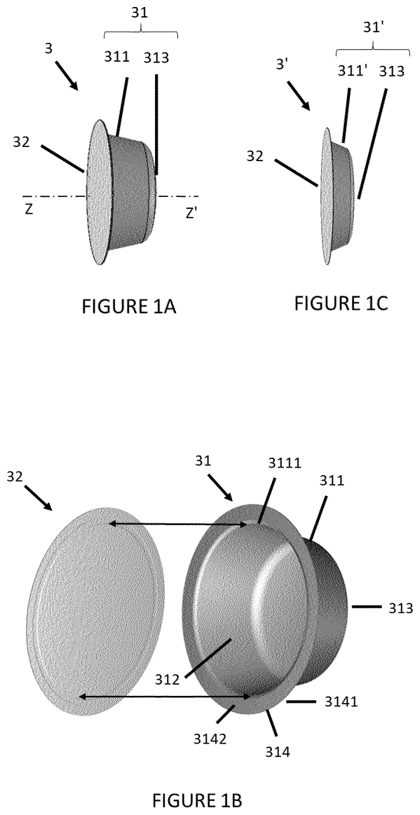

FIGS. 1A (perspective view) and 1B (exploded view) illustrate a pod 3 that can be used in the extraction device of the invention.

The pod 3 comprises a pod body 31 with one sidewall 311 that extends axially from a bottom wall 313 towards a top. The sidewall 311 extends towards a top opening 312. At the top opening 312, the body comprises a circumferential annular flange 314 that extends radially outward from the sidewall 311 along the circumference of the opening 312.

The flange comprises an upper surface 3142 facing the top and a lower surface 3141.

Generally, any transversal cross section of the body is circular from the bottom to the top and the flange is circular too.

The body delimits a chamber for containing a beverage ingredient.

This beverage ingredient is preferably an ingredient able to be extracted like roast and ground coffee.

In a less preferred manner, the beverage ingredient can be tea leaves or a water soluble powder ingredient such as: instant coffee powder, milk powder, cream powder, instant tea powder, cocoa powder, soup powder, fruit powder or mixture of said powders or even a soluble liquid ingredient or a beverage concentrate such as a syrup or milk concentrate. The powders can be agglomerated or sintered.

The capsule comprises a lid 32 that is fixed, sealed or attached to at least a part of the upper surface 3142 of the circumferential flange and accordingly covers and closes the top opening 312.

The bottom wall 313 is adapted to be pierced so that liquid can be injected in the pod through the pierced openings.

The lid 32 is adapted to be opened by relative engagement with a piercing arrangement under the effect of the liquid pressure increase inside the pod during injection of liquid.

The pod shape is symmetric relatively to the central axial axis ZZ′ extending from the bottom wall to the lid and the pod shape is asymmetrical relatively to the plane of the lid and the flange.

FIG. 1C illustrates another pod 3′ that can be used in the extraction device of the invention and differ from the pod 3 of FIG. 1A only by the depth size (along axis ZZ′) of the pod bodies 31′. The pod body 31 of the big pod 3 defines an ingredient chamber with a bigger volume than the pod body 31′ of the small pod 3′, the side wall 311 being higher than the side wall 311′. The diameter of the lids 32, 32′ of the small and big pods are identical.

This difference in sizes enable the preparation of different beverages, preferably different coffee beverages like ristretto, espresso, lungo (long cups), americano, . . .

Other sizes than those illustrated can be provided, like an intermediate size.

In one preferred embodiment, the pods 3 can be mase essentially of a biodegradable or compostable material, preferably a home compostable material since extracted coffee cakes can easily be made composted at home.

Preferably, the material of the pod comprises a paper layer. This paper layer is formable, i.e. a sheet of paper can be given a three-dimensional shape that is the form of the body of the above described pod. Contrary to common pods made of filter paper, this paper is thick and keep the three-dimensional shape provided during a shaping step of manufacturing of the pod.

Preferably, the paper layer of the pod can have a grammage of at least 20 g/m², preferably at most 150 g/m². The paper of the body can present a higher grammage than the paper of the lid because it needs to be stretched and deformed during manufacturing.

The grammage of the paper of the body can be comprised between 80 and 150 g/m².

The lid can present a grammage comprised between 20 and 120 g/m².

Both papers can present a grammage of about 100 g/m².

The material of the pod can comprise a layer of paper and some other materials to provide additional properties such as air barrier, stretchable or deformable properties. These additional properties can be provided with at least one plastic layer, for example as described in WO 2020/114995. Some additional layers of the body and of the lid can be different.

In fact, in order to shape the paper as a container for the beverage and to create a barrier to protect the beverage ingredient, the paper must be sufficiently thick. In addition, to create a barrier to atmosphere, in particular oxygen to which roast and ground coffee is particularly sensitive, the layer of paper is preferably coated with a compostable plastic film. Sealants layers are often necessary to attach the different layers and prevent delamination. For example, such a multilayer paper material can be the material described in WO 2020/114995 or in application PCT/EP21/067316.

With such pod materials, the thickness of the multilayer paper material of the body can be about 200 μm and the thickness of the multilayer paper material of the lid can be about 140 μm which means that the thickness of the flange is usually greater than 200 μm, even greater than 300 μm.

The manufacturing of such particular pods comprises generally the steps of:
providing a first sheet of deformable paper material of circular shape, the diameter of said first sheet being adapted to the size of pod to be produced (small or big),
deforming said first sheet in order to shape the pod body with a flange therefrom. this operation is usually obtained by shaping the first sheet in a dedicated recess, die or mould that presents the shape of the pod body.
filling the shaped body with a dose of beverage ingredient, preferably roast and ground coffee, and preferably compacting said dose of roast and ground coffee inside the shaped pod,
providing a second sheet of material of circular shape, the diameter of said second sheet corresponding to the diameter of the lid of the pod, whatever the size of the pod to be produced (small or big),
sealing this second sheet on the flange of the filled shaped body.

Due to the nature of the paper material, that is an heterogenous material (random position of the plant fibres in the sheet), and due to the thickness of the paper material, the shaping of the first sheet of material produces pods with particular features that impact the preparation of a beverage within an extraction device.

The shaping of the paper material in a mould leads to the creation of wrinkles all along the periphery of the side wall 311 and of the bottom face 3142 of the flange. Within the bigger pods (FIG. 1A), the wrinkles are even more important and deeper since the original diameter of the first sheet is quite larger than the final diameter of the pod. For example, with a first sheet disc presenting a thickness of about 200 μm and a diameter of 70 mm and used to produce a final pod presenting a lid diameter of about 53 mm and a pod body diameter of about 48 mm (diameter below the flange of the flange), the depth of the wrinkles in the formed body can vary between 25 and 200 μm (measured with an interferometer). These wrinkles impact the tightness of the extraction chamber during the beverage preparation. The depth of the more important wrinkles can reach almost 200 μm.

The extraction device of the present invention can be configured for using alternative containers to those described above as soon as they comprise a body defining a chamber and a lid to close the chamber. Usually, the two enclosing parts present internal shapes conformal to the containers.

For example, the container can be a frusto-conical capsule made of aluminum or plastic.

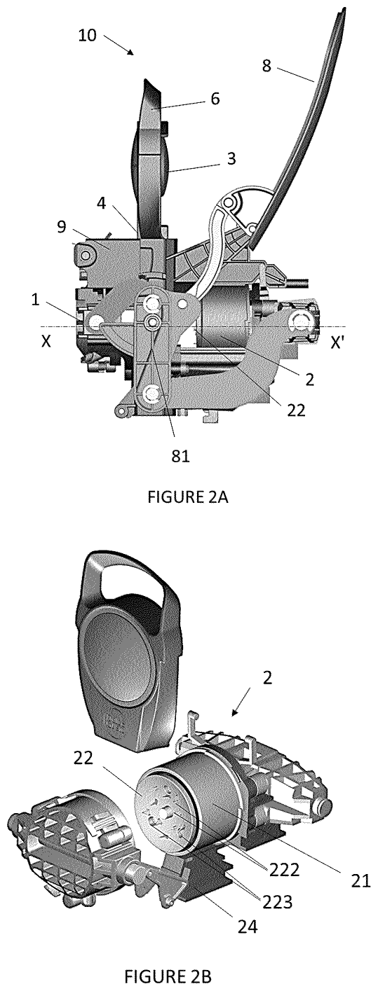

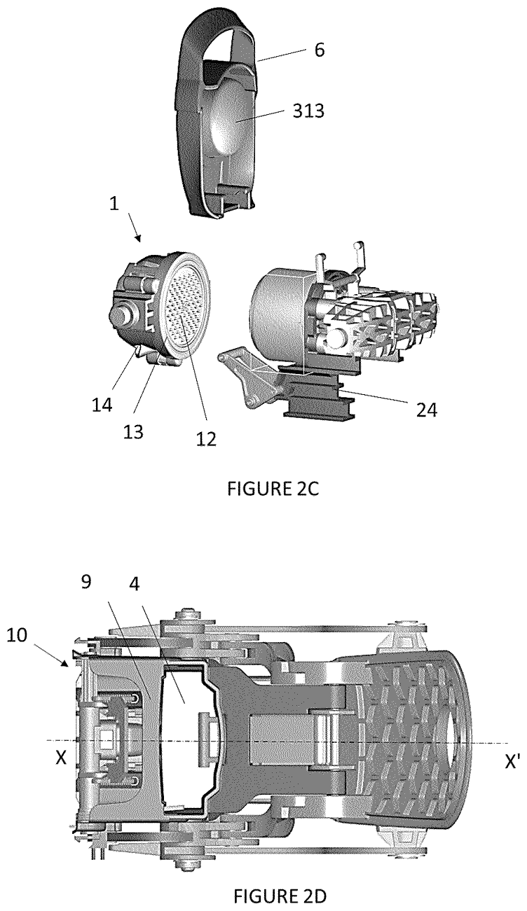

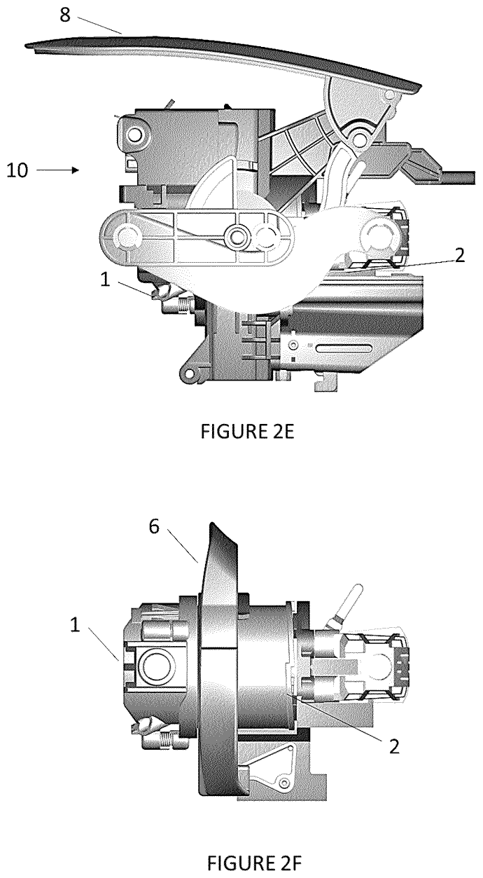

FIG. 2A is a side view of an extraction device 10 according to the invention comprising an upstream pod enclosing part 2 and a downstream pod enclosing part 1 relatively translatable along a longitudinal axis XX′. Usually, this axis XX′ is essentially horizontal. In FIG. 2A, these two parts are in an opened position configured to receive a pod for extraction. These two enclosing parts are supported by a chassis 9 and made movable from said opened position to a closed position by actuating a handle 8 connected to these enclosing parts by a system 81 of interrelated knee levers.

The device comprises a pod holder 6 that holds a pod 3. This holder is fully removable form the extraction device and is illustrated in FIG. 2A outside the chassis where it is ready for an operation of introduction between the enclosing parts or at the end of said operation during the removal of the extracted pod form the extraction device. The pod is introduced through an insertion section 4 positioned above the two enclosing parts 1, 2.

FIGS. 2B and 2C are perspective and isolated view of the two pod enclosing parts 1, 2 and the pod holder 6 in the position illustrated in FIG. 2A.

The downstream part 1 comprises a plate perpendicular (that is transverse) to the longitudinal axis XX′. This plate comprises a central downstream plane piercing arrangement 12 for opening the lid 32 of the pod when the extracting liquid is introduced inside the pod and inflates the lid. Usually, this central downstream plane piercing arrangement 12 is circular like the lid of the pod.

Opening happens by relative engagement of spikes with the lid under the effect of the rise in pressure of the injected liquid in the pod body chamber. This downstream plane piercing arrangement may comprise a rigid plate comprising opening elements 121 such as spikes, that can present the shape of cones or pyramids, optionally truncated at their ends, on its surface turned to the lid. In addition, the plate comprises traversing holes to evacuate the beverage dispensed from the opened lid to a beverage outlet 14, such as a tube or nozzle collecting and dispensing beverage to a drinking cup.

The plate comprises a peripheral area 13 surrounding that piercing arrangement 12.

The upstream part 2 defines a cage 21 or cavity for enclosing the pod body. This cage presents an adjustable internal volume. A movable end wall 22 transverse to the longitudinal axis XX′ of the cage enables this adjustment. This end wall 22 bears piercing elements 222 for opening the bottom wall 313 of the pod body and liquid outlet openings 223 for supplying liquid into the pod through the holes opened in the bottom wall of the pod. These piercing elements can comprise piercers in the form of blades. These blades can be designed and positioned to pierce the wall of the bottom of the pod body when the upstream and downstream pod enclosing parts are brought to the closed position. The liquid outlet openings 223 can form a shower at the front face of the end wall of the cage and the supplied liquid can be introduced in the pod through the pre-pierced openings.

Since pods 2 of different sizes can be introduced and extracted, the end wall 22 of the cage can be made movable to adapt the cage internal volume to the pod.

The upstream part 2 is supported by a carrier 24 that enables its movement along the axis XX′.

The top view of the extraction device in FIG. 2D shows the insertion section 4 for the pod holder that is provided in the chassis 9. This insertion section 4 is designed to enable the introduction of the pod holder 6 so that the lid 32 of the pod hold in the holder is positioned in front the of the downstream enclosing part 1.

FIGS. 2E and 2F illustrate the extraction device of FIGS. 2A-2C wherein the pod holder 6 is positioned between the upstream pod enclosing part 2 and the downstream pod enclosing part 1 and these two parts have been moved one to the other by actuation of the interrelated levers by the handle 8. In this position, the pod holder 6 is firmly pinches between the two enclosing parts as 1,2.

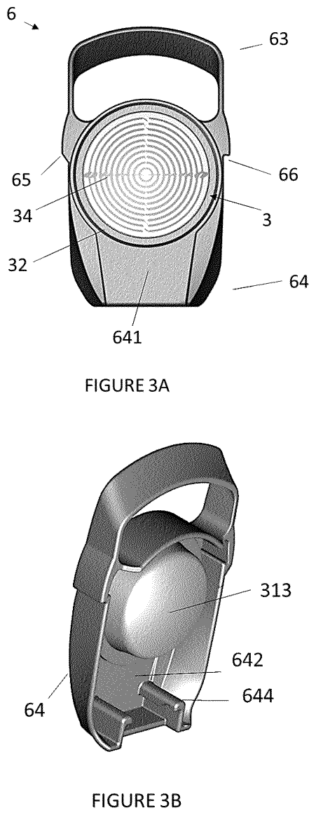

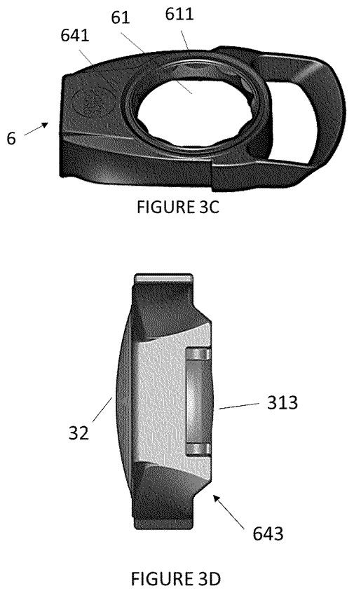

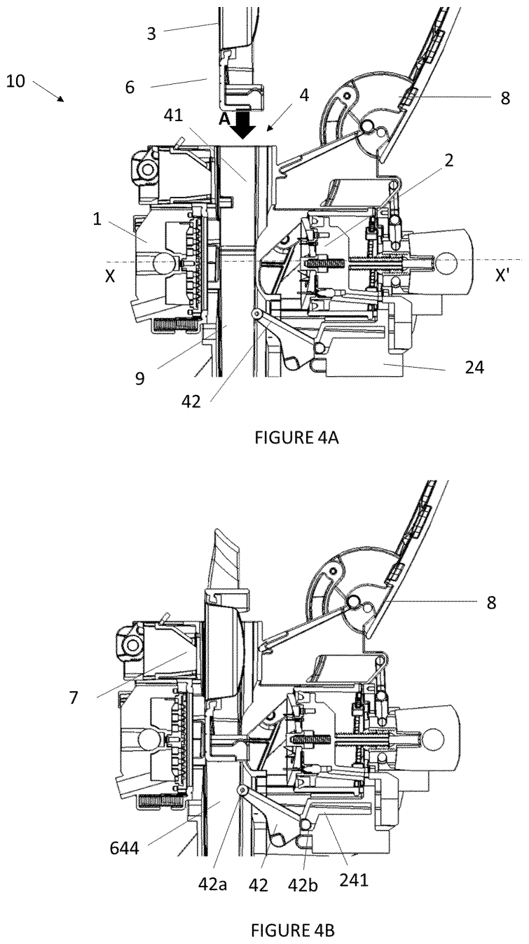

FIG. 3A is a perspective view of the pod holder 6 holding a pod 3 and showing the front face 641 of the pod holder on which the lid 32 of the pod is positioned. FIG. 3B shows the back face 642 of the pod holder on which the bottom 313 of the pod emerges. FIG. 3C is a perspective view of the holder without any pod.

In its front face 641, the pod holder 6 presents a hole 61 through which the body 31 of the pod can be received. The holder and its hole are designed so that once the pod 3 is positioned in the hole 61, at least a part of the lid 32 and at least a part of the bottom 313 of the pod is not covered or enclosed by the pod holder and remains accessible for being pierced by the downstream and upstream pod enclosing parts during the beverage preparation. In the particular above illustrated embodiment of the extraction device, the piercing elements 12, 222 of the downstream and upstream enclosing parts are configured to pierce large surfaces of the lid 32 and of the pod bottom 313; accordingly, the holder does not comprise any shell that covers the bottom of the pod body: the bottom remains uncovered and accessible for piercing.

With other types of piercing elements of the extraction device, piercing may be provided in more limited areas of the lid and/or of the bottom and the holder may comprise some parts to enclose the pod except at that pierceable areas.

In the illustrated embodiment, the holder can comprise some retaining elements at the internal surround of the hole. These retaining elements, such as the illustrated short flexible tongues 612, can maintain the pod inside the holder by friction when the pod holder is manipulated by the user and is introduced vertically inside the insertion section.

A handle 63 facilitates the handling by the user, in particular by urging the user to orientate the holder with the pod handle positioned upwardly during the introduction of the pod holder in the insertion section, that is with the lid 32 in front of the downstream part 1 and the pod bottom 313 in form of the upstream part 2.

As illustrated in FIG. 3D, the shape of the bottom 643 of the pod holder is asymmetric. This asymmetric shape is identical to the shape of the insertion section 4 so that the user is urged to position the pod correctly between the upstream and enclosing parts as mentioned above in relation with FIG. 2D.

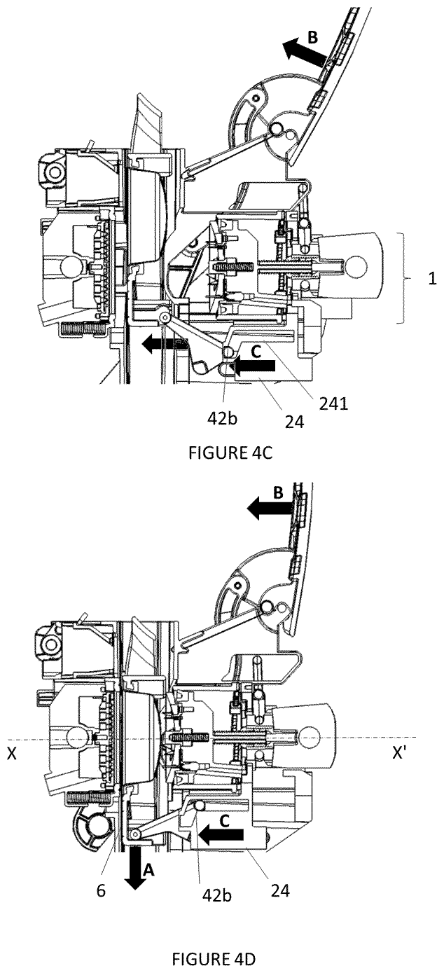

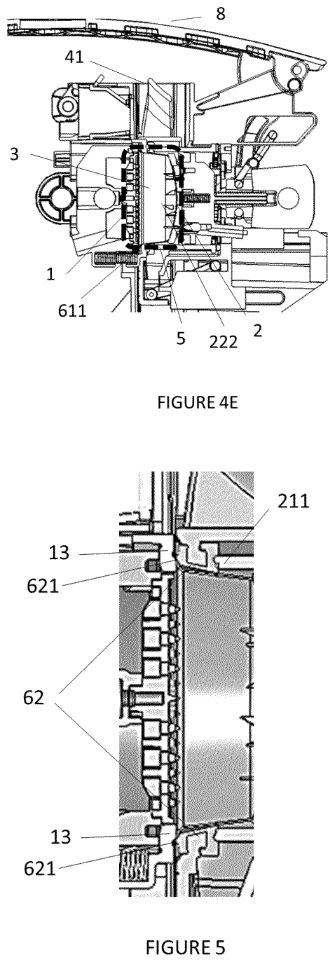

FIGS. 4A-4E illustrate the steps of introduction of the pod holder 6 inside the extraction device 10 according to the preferred embodiment.

In FIG. 4A:
the handle 8 is in the open position where:
   it does not cover the insertion section 4, and
   it positions the two enclosing parts 1, 2 away one from the other,
the pod holder 6 was loaded with a pod 3 and is positioned above the insertion section 4: it is being slidden vertically inside the path 41 as illustrated by the arrow A.

In FIG. 4B:
the pod holder 6 was introduced in the path 41 by the user and is retained in an intermediate temporary position inside the path 41 by a stopper 42 on which the pod holder abuts. A downstream end 42a of this stopper 42 is configured to be positioned inside the path 41 when the handle 8 is in the open position so as to interact with the bottom 643 of the pod holder and to stop its downwards sliding movement operated by the user.

This intermediate position can enable an operation of identification or recognition of the pod by a recognition device 7 positioned in that part of the path 41 before the pod is introduced further between the enclosing parts 1, 2. This recognition device can obtain input information for the further preparation of a beverage from the recognised or identified pod.
simultaneously the downstream end 42a of the stopper becomes engaged in a slot 644 designed through the bottom 643 of the holder. This engagement is going to enable the automatic driving of the pod holder 6 to its final downwards position between the two enclosing parts 1, 2 as explained bellow.

In FIGS. 4C:
the user starts moving the handle 8 to its closed position as illustrated by arrow B.
due to the system 81 of interrelated knee levers between the handle 8 and the carrier 24 of the upstream enclosing part 2, this upstream part starts moving in direction of the downstream part 1 as illustrated by arrow C. In this preferred illustrated embodiment, the downstream pod enclosing part 2 is moving too in direction of the upstream part by means of the system 81 of interrelated knee levers.
the upstream end 42b of the holder stopper is connected to this movable carrier 24: it is engaged in a slot 241 of the carrier. Accordingly, since the stopper is engaged in the slot 644 of the holder and of the pod holder 6, the own movement of the carrier 24 induces simultaneously the movement of the stopper 42. The slots 644, 241 in the pod holder 6 and in the carrier 24 respectively are designed so that the movement of the upstream pod enclosing part 2 to the downstream pod enclosing part, that is the closure of the extraction chamber, induces the downwards movement of the pod holder between these two enclosing parts 1, 2 before these two parts form the extraction chamber.

In FIG. 4D:
the handle 8 goes on closing and the carrier 24 of the upstream enclosing part 1 goes on moving to the downstream part 1 in order to close the extraction chamber,
but the pod holder 6 stops sliding down due to the design of the slot 241 that is followed by the upstream end 42b of the stopper in the carrier. At this step of closure of the handle 8, the pod holder 6 is well aligned between the two enclosing parts 1, 2 and along the longitudinal axis XX′.

In FIG. 4E:
the handle 8 has reached its closing position and covers the path 41 of the insertion section.
the downstream and upstream enclosing parts 1, 2 and the holder 6 form an extraction chamber 5 (in dotted line) that encloses the pod 3. The bottom 313 of the pod is pierced by the piercing elements 222 and the preparation of the beverage can start by introducing liquid through the liquid outlets 223 of the upstream enclosing part.

FIGS. 4F-4H illustrate the steps of removal of the pod holder from the extraction device after the extraction operation of FIG. 4E.

These steps happen while the user pulls the handle 8 to open the extraction device and movements exactly opposed to those described in FIGS. 4C to 4E happen.

In FIG. 4F, the user started pulling upwardly the handle as illustrated by arrow D with the effect that the carrier 24 of the upstream enclosing part 2 has moved away from the pod holder 6 as illustrated by the arrow E. The two enclosing parts 1, 2 makes the pod holder free.

In FIG. 4G, the user goes on pulling the handle 8 and the downstream end 42a of the stopper of the pod holder is pushing the pod holder upwardly as illustrated by the arrow F.

In FIG. 4H, the stopper 42 is not engaged in the slot 644 at the bottom of the pod holder and the pod holder 6, that is now in the intermediate position back and can be pulled out of the insertion path by the user in order to throw the extracted pod away.

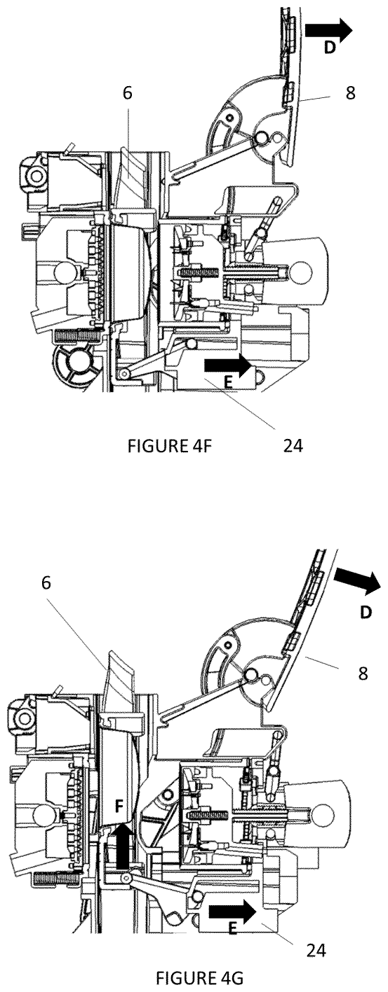

FIG. 5 is a magnified view of the interaction of the pod holder 6 with the upstream and downstream enclosing parts 1, 2 when the extraction chamber is formed. Preferably, the pod holder comprises a seal 62 that covers all the front face and all the back face of the surround 611 of the receiving hole of the pod holder and that can cooperate with the respective surrounds of the upstream and downstream enclosing parts 1, 2 to provide tightness during the beverage preparation, in particular the edge 211 of the cage can engage with the seal at the back face of the surround of the hole and the peripheral area 13 of the downstream enclosing part can engage with the seal at the front face of the surround of the hole.

In addition, the pod holder 6 can be designed so that the annular flange 314 of the pod is pinched between the front face of the surround of the hole and the surround of the peripheral area 13 downstream enclosing part.

Preferably, the seal at the front face of the surround of the hole comprises a ridge 621 that extends along the periphery of the seal and that rises in the downstream direction.

Accordingly, in the closed position of the enclosing parts 1, 2, the flange 314 of the pod can be pressed between the seal 62 and the surround of the downstream part and can be pinched strongly by the ridge. As a result, in the flange, the paths for liquid created by the presence of potential wrinkles around the flange of the pod are closed and tightness is obtained. This embodiment is particularly useful when pods made of paper such as described above are used. In one preferred embodiment, the peripheral area 13 of the downstream part can comprise a groove 131 in which this ridge 621 can engage to increase tightness even more.

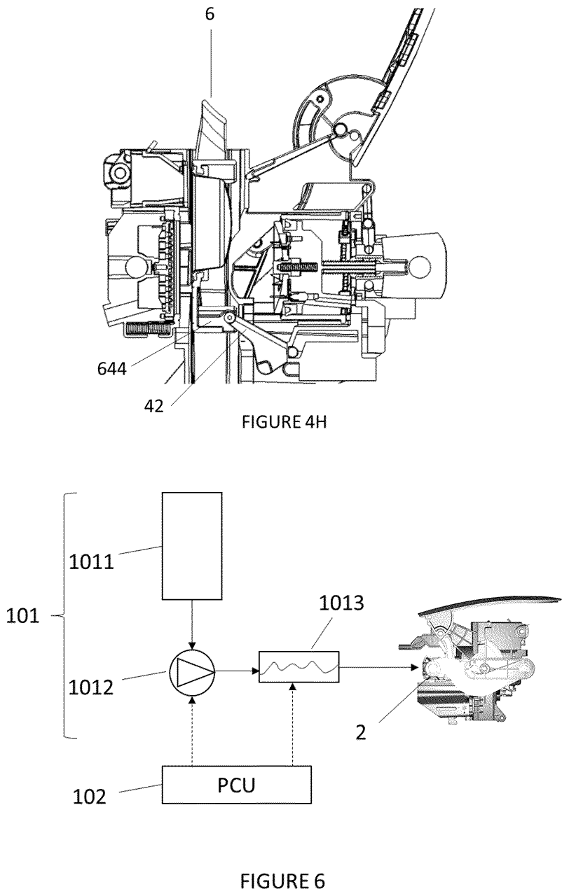

FIG. 6 illustrates the fluid system 101 of the extraction device and configured to supply the upstream enclosing part 2 with liquid. This system 101 can comprise a tank 1011 of fluid, generally water, a pump 1012 to pump that fluid form the tank and at least one device to adapt the temperature of the fluid like a heater 1013 and/or a cooler before the fluid is dispensed to the upstream part 2.

A process control unit 102 of the beverage machine is configured to control the pump and the heater once a beverage is ordered.

This unit 102 can be used to control other controllable devices like the recognition device or a display if present.

Although the invention has been described with reference to the above illustrated embodiments, it will be appreciated that the invention as claimed is not limited in any way by these illustrated embodiments.

Variations and modifications may be made without departing from the scope of the invention as defined in the claims. Furthermore, where known equivalents exist to specific features, such equivalents are incorporated as if specifically referred in this specification.

As used in this specification, the words “comprises”, “comprising”, and similar words, are not to be interpreted in an exclusive or exhaustive sense. In other words, they are intended to mean “including, but not limited to”.

### LIST OF REFERENCES IN THE DRAWINGS

| | |
|---|---|
| beverage device | 100 |
| extraction device | 10 |
| downstream enclosing part | 1 |
| downstream piercing arrangement | 12 |
| spikes | 121 |
| peripheral area | 13 |
| groove | 131 |
| beverage outlet | 14 |
| upstream enclosing part | 2 |
| cage | 21 |
| edge | 211 |
| end wall | 22 |
| piercing elements | 222 |
| liquid outlets | 223 |
| carrier | 24 |
| slot | 241 |
| pod | 3, 3′ |
| body | 31, 31′ |
| side wall | 311, 311′ |
| top end | 3111 |
| top opening | 312 |
| bottom wall | 313 |
| annular flange | 314 |
| top face | 3141 |
| bottom face | 3142 |
| lid | 32 |
| annular area | 321 |
| peripheral annular area | 322 |
| insertion section | 4 |
| path | 41 |
| holder stopper | 42 |
| extraction chamber | 5 |
| removable pod holder | 6 |
| pod receiving hole | 61 |
| hole surround | 611 |
| tongue | 612 |
| seal | 62 |
| ridge | 621 |
| handle | 63 |
| front face | 641 |
| back face | 642 |
| bottom | 643 |
| slot | 644 |
| recognition device | 7 |
| actuator | 8 |
| interrelated knee levers | 81 |
| chassis | 9 |
| fluid supply system | 10 |
| tank | 1011 |
| pump | 1012 |
| heater | 1013 |
| process control unit | 102 |

The invention claimed is:

1. An extraction device for extracting a beverage ingredient by supplying an extraction liquid into a pod,
said pod comprising:
a pod body, said pod body comprising a side wall and a bottom wall defining a chamber, and
a top lid closing the top opening of the pod body,
and
said extraction device comprising:
upstream and downstream pod enclosing parts relatively movable, along a horizontal longitudinal axis between an open position for inserting and removing the pod and a closed position for forming an extraction chamber enclosing the pod during extraction, and
a removable pod holder, said holder comprising a pod receiving hole to receive and hold the pod, and
a top insertion section configured for introducing the pod holder in the device and positioning said holder between the upstream and downstream pod enclosing parts,
wherein the top insertion section is configured to introduce the holder along a vertical direction from the top of the device, and
wherein the pod receiving hole and the top insertion section are configured to position the lid of the pod vertically when the removable pod holder s introduced inside the device.

2. Extraction device according to claim 1, wherein the upstream enclosing part bears an upstream piercing arrangement for opening the bottom wall of the pod and a liquid injector, and the downstream enclosing part comprises a downstream piercing arrangement for opening the lid of the pod.

3. Extraction device according to claim 1, wherein the holder and pod receiving hole are designed so that once the pod is positioned in the hole, at least a part of the lid of the pod and at least a part of the bottom of the pod are not covered by the pod holder and are accessible for being pierced by the downstream and upstream pod enclosing parts during extraction.

4. Extraction device according to claim 1, wherein each of the downstream and upstream parts are movable between a respective open position for inserting and removing the pod holder and a respective closed position for forming an extraction chamber enclosing the pod holder during extraction.

5. Extraction device according to claim 1, wherein the top insertion section comprises a path for guiding the pod holder to the extraction area between the upstream and downstream pod enclosing parts, and
wherein said extraction device comprises a holder stopper to stop the pod holder in an intermediate temporary position inside said path.

6. Extraction device according to claim 1, wherein said extraction device comprises a recognition device configured to recognise or identify a pod hold in the pod holder when the pod holder is in the intermediate temporary position.

7. Extraction device according to claim 5, wherein the extraction device comprises an actuating member to move the pod holder from the intermediate position to the extraction area between the upstream and downstream pod enclosing parts.

8. Extraction device according to claim 1, wherein said actuating member is cinematically linked to the holder stopper so that said stopper is configured to drive the pod holder from the intermediate position to the extraction area when said actuating member is operated.

9. Extraction device according to claim 1, wherein the pod holder and the holder stopper are designed so that the holder stopper is able to engage a surface of the pod holder.

10. Extraction device according to claim 7, wherein the actuating member comprises a handle, and said handle closes the path of the top insertion section when the downstream and upstream parts are in the closed position.

11. Extraction device according to claim 7, wherein the actuating member is configured to move each of the upstream and downstream parts between the open position and the closed position of said parts.

12. Extraction device according to claim 1, wherein, when the pod holder is in the extraction area and the upstream and downstream enclosing parts are in the closed position, the surround of the receiving hole of the pod holder is pinched between the upstream and downstream enclosing parts.

13. Extraction device according to claim 1, wherein the pod holder comprises a plate, said plate comprising the hole for receiving the pod, said plate comprising a front face and a back face, and
wherein the pod holder comprises a seal, said seal covering all the front face and the back face of the surround of the receiving hole of the pod holder.

14. Extraction device according to claim 1, wherein the part of the seal covering the front face of the plate of the pod holder comprises a ridge, said ridge rising in the downstream direction, and
the downstream enclosing part defines a plate transverse to the longitudinal axis, said plate comprising:
a downstream plane piercing arrangement for opening the lid of the pod,
and
a peripheral area,
and said peripheral area of the downstream enclosing part comprises a groove conformal to the shape of the ridge of the seal, and when the upstream and downstream pod enclosing parts are in the closed position the ridge is positioned inside said groove.

15. (canceled)

16. System comprising an extraction device for extracting a beverage ingredient by supplying an extraction liquid into a pod,
said pod comprising:
a pod body, said pod body comprising a side wall and a bottom wall defining a chamber, and
a top lid closing the top opening of the pod body,
and
said extraction device comprising:
upstream and downstream pod enclosing parts relatively movable, along a horizontal longitudinal axis between an open position for inserting and removing the pod and a closed position for forming an extraction chamber enclosing the pod during extraction, and
a removable pod holder, said holder comprising a pod receiving hole to receive and hold the pod, and
a top insertion section configured for introducing the pod holder in the device and positioning said holder between the upstream and downstream pod enclosing parts,
wherein the top insertion section is configured to introduce the holder along a vertical direction from the top of the device, and
wherein the pod receiving hole and the top insertion section are configured to position the lid of the pod vertically when the removable pod holder is introduced inside the device and a pod,
wherein said pod comprises:
a pod body, said pod body comprising a side wall and a bottom wall defining a chamber, and
a top lid closing the top opening of the pod body.

17. Method to prepare a beverage with an extraction device for extracting a beverage ingredient by supplying an extraction liquid into a pod,
said pod comprising:
a pod body, said pod body comprising a side wall and a bottom wall defining a chamber, and
a top lid closing the top opening of the pod body,
and
said extraction device comprising:
upstream and downstream pod enclosing parts relatively movable, along a horizontal longitudinal axis between an open position for inserting and removing the pod and a closed position for forming an extraction chamber enclosing the pod during extraction, and
a removable pod holder, said holder comprising a pod receiving hole to receive and hold the pod, and
a top insertion section configured for introducing the pod holder in the device and positioning said holder between the upstream and downstream pod enclosing parts,
wherein the top insertion section is configured to introduce the holder along a vertical direction from the top of the device, and
wherein the pod receiving hole and the top insertion section are configured to position the lid of the pod vertically when the removable pod holder is introduced inside the device, wherein the extraction device comprises an actuating member, said method comprising the steps of:
removing the pod holder from the extraction device,
introducing a pod in the pod holder,
introducing the pod holder in the extraction device down to a temporary position,
actuating the actuating member to move the pod holder from the intermediate position to the extraction area.

18-19. (canceled)
